(19) United States
(12) Patent Application Publication
(10) Pub. No.: US 2010/0099055 A1
(43) Pub. Date: Apr. 22, 2010

(54) Dental Laser Treatment Instrument Comprising an Optical Extraction Element

(75) Inventors: Emanuel Von Kienlin, Muenchen (DE); Thomas Jaeggle, Hochdorf (DE); Bernd Liebermann, Berg (DE); Ursula Schmitt, Assmannshardt (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: KALTENBACH & VOIGT GMBH, Biberach (DE)

(21) Appl. No.: 12/531,213

(22) PCT Filed: Mar. 13, 2008
(86) PCT No.: PCT/EP2008/002027

§ 371 Date: Nov. 10, 2009

(30) Foreign Application Priority Data
Mar. 19, 2007 (DE) 10 2007 013 066.1

(51) Int. Cl. A61C 3/00

(52) U.S. Cl. 433/29

(57) ABSTRACT

A dental laser treatment instrument comprising a handpiece that is connected to a supply tube for supplying laser radiation and a treatment fluid, and has a long extraction element on the front end thereof, for emitting the laser radiation. The extraction element has a long optical fiber and a cylindrical or sleeve-type holding element which surrounds the optical fiber in a region facing the front end of the fiber, at a distance from said fiber, in order to form a fluid channel. The fluid channel is connected to a supply line extending through the handpiece. According to the invention, the sleeve-type holding element projects past the front optical output end of the optical fiber.

The present invention relates to a dental laser treatment instrument according to the preamble of claim 1, which comprises a handpiece as well as an elongate extraction element located at the front end of the handpiece for emitting the laser radiation.

Apart from the classical treatment of dental tissue by means of mechanical processing, the use of so-called dental lasers has recently increasingly established itself. In the case of such devices, the tissue to be treated, for example the dental tissue, is irradiated by means of high energy electromagnetic radiation, which ultimately results in thermal heating and finally evaporation of the radiated tissue. Also, similar to the case where a classical dental drill is used, material may be removed in this way in order to remove for example areas showing dental decay or to machine cavities into a tooth.

In particular in the area of dental medicine, so-called solid-state lasers of the type Er:YAG have gained acceptance. These lasers have a wavelength which possesses the particular property that it matches the maximum of the absorption spectrum of water, which due to the fact that as a rule the tissue to be treated contains water, ultimately leads to a high removal efficiency with minimum thermal influences.

The transfer of the laser radiation onto the dental surface to be treated may be carried out in various ways. On the one hand, laser treatment instruments are known in which the laser radiation is emitted laterally via a window located at the front end of the handpiece. In this case, the handpiece is held at a certain distance from the dental surface to be treated. Further, also so-called Paro-handpieces are known, which were originally designed for the treatment of subgingival locations. These include an optical extraction element laterally protruding from the handpiece, which may be inserted e.g. into the periodontal pockets in order to treat the epithelial lining of the pockets. Here, infected soft tissue may be efficiently removed, while at the same time the root surface of a tooth is protected as well as possible. Apart from that, such handpieces may also be used for treating dental surfaces. In this case, the optical extraction element is either placed directly on the dental surface or is held at a small distance therefrom.

Owing to the fact that the heating that takes place while such a laser is used on the material to be treated, it is necessary to ensure that the surrounding tissue is suitably cooled during the treatment. Also, the radiated area needs to be rinsed so that any material taken off may be removed and the treatment may be carried out in an optimal manner. In this connection, it is already known to provide laser handpieces with an integrated water supply. Here, water is supplied by means of a supply line in such a manner that the extraction element is rinsed.

A solution for realising such an integrated water supply is known for example from U.S. Pat. No. 6,567,582. According to this, a specially designed sleeve-type holding element for holding the optical extraction element is provided, which surrounds an optical fiber provided for emitting radiation partially at a distance. By this means, an annular channel extending in a longitudinal direction of the optical fiber is formed, via which ultimately an air-water mix is to be dispensed in the form of a spray.

Further, the U.S. Pat. No. 5,304,167 describes a dental laser treatment device including lenses or wedges of light at the front end of a light emitting element, which are used to focus the radiation onto a certain treatment area. In this case it is necessary for an optimal utilization of the laser radiation to hold the tip at a certain distance from the surface.

On the basis of this prior art it is the object of the present invention to provide an improved dental laser treatment instrument, wherein on the one hand the handling of the treatment instrument is to be facilitated for a user with a view to an optimal utilization of the laser radiation, and further, a water rinsing system which is as efficient as possible is to be provided.

The object is achieved by means of dental laser treatment instruments having the features of the independent claims. Advantageous further developments of the invention are the subject matter of the dependent claims.

A first aspect of the present invention herein relates to the embodiment of the optical extraction element. It is provided herein that this has an elongate optical fiber for emitting laser radiation which is surrounded by a sleeve-type holding element forming a fluid channel which surrounds the optical fiber. Contrary to the solution known from U.S. Pat. No. 6,567,582 it is provided herein that the sleeve-type holding element extends beyond the front light output end of the optical fiber.

According to this first aspect, a dental laser treatment instrument having a handpiece is suggested, which is to be connected to a supply tube for supplying laser radiation as well as a treatment fluid, and at the front end of which an elongate extraction element for emitting the laser radiation is disposed, with the extraction element having an elongate optical fiber as well as a cylinder- or sleeve-type holding element which surrounds the optical fiber at a distance in an area associated with the front end of the fiber in order to form a fluid channel, and wherein the fluid channel is connected with a supply line extending through the handpiece, whilst it is provided according to the invention that the sleeve-type holding element extends beyond the front light output end of the optical fiber.

The measure according to the invention, namely to insert a sleeve extending beyond the optical fiber, brings about several advantages. On the one hand, it becomes possible in this way to place the extraction element during the treatment of the surface of the tooth directly onto this surface, and in this case the light output end of the optical fiber will then be located at a defined distance from the tooth surface. This ensures an optical alignment and focusing of the laser radiation on the area to be treated at all times. Further, it has been shown that owing to the fact that the annular fluid channel surrounding the optical fiber is taken right up to the front end, a particularly effective supply of the treatment fluid is achieved. Accordingly, this allows an effective cooling of the dental surface to be treated, without there being any risk that the surrounding areas are heated in an undesired manner.

According to an advantageous further development of the invention it may be provided that the sleeve-type holding element has lateral openings in the area extending beyond the optical fiber. In this way it is achieved that the treatment fluid, including any particles removed from the dental surface, may be laterally carried off. This means that an improved cooling and rinsing of the surface to be treated is achieved. To this end, the front face area of the sleeve section may be perforated or may include lateral bores.

A further development designed to achieve an effective cooling of the surface to be treated is also the subject matter of a second aspect of the present invention. It is provided herein that the optical fiber is supported by a holding element in the front area of the handpiece, which is connected to a supply line for the treatment fluid, which extends through the handpiece and which is designed for dispensing the treatment fluid. In order to achieve a particularly effective cooling and rinsing, it is provided that the holding element has several outlets for the treatment fluid, which are distributed around the optical fiber. In an ideal case, a ring-shaped arrangement of several nozzles is achieved, through which the treatment fluid is dispensed.

This means that according to this second aspect of the present invention, a dental laser treatment instrument having a handpiece is suggested, which is to be connected by means of a supply tube for supplying laser radiation as well as a treatment fluid, and at the front end of which an extraction element having an elongate optical fiber for emitting the laser radiation is disposed, with the handpiece further including a holding element for the optical fiber which is connected to the supply line extending through the handpiece and which is formed for dispensing the treatment fluid, and wherein according to the invention, the holding element has several outlets for the treatment fluid, which are distributed around the optical fiber.

Finally, a third aspect of the present invention relates to measures for focusing the laser radiation onto the area to be treated. According to the invention it is provided herein that the laser radiation is focused onto an area located upstream of the light output end of the optical fiber, wherein the means for focusing are either disposed upstream of the optical fiber or are formed by the light entry area of the fiber.

According to the third aspect, a dental laser treatment instrument having a handpiece is suggested, at the front end of which an extraction element having an elongate optical fiber for emitting laser radiation is located, wherein the handpiece has means for focusing the laser radiation onto an area located upstream of the light output end of the optical fiber, and wherein the means for focusing are located upstream of the optical fiber or are formed by the light entry area of the optical fiber.

Accordingly, the present invention distinguishes itself from the solution known from U.S. Pat. No. 5,304,167 in that the laser beam is not focused through the light-emitting element itself or through its light output area itself, but is focused through the light-conducting element. To this end, elements disposed upstream of the optical fiber, in particular lenses and the like, may be provided. However, it may also be provided that by means of an appropriate design of the light entry area of the optical fiber, the laser radiation is orientated in the desired manner. As a result of these measures, a particularly good and efficient focusing of the laser radiation may be achieved, which ultimately means that this will be utilized in an optimal manner for treating the dental surface.

Ultimately, the three above-mentioned aspects of the invention, which may, if needed, also be combined with each other, contribute to providing a novel dental laser treatment instrument which allows optimum handling for a user and at the same time ensures an efficient utilization of the laser radiation as well as cooling and rinsing of the surface to be treated.

The invention will be explained in more detail below by means of the attached drawings, wherein:

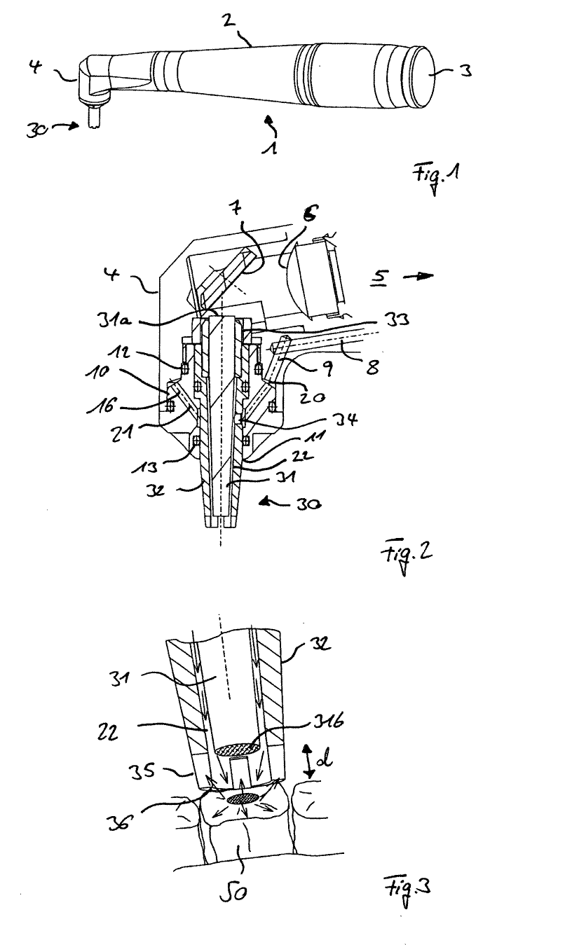

FIG. 1 shows a first embodiment example of a dental laser treatment instrument according to the invention in a perspective view;

FIG. 2 shows a sectional view of the front head area of the laser treatment instrument of FIG. 1;

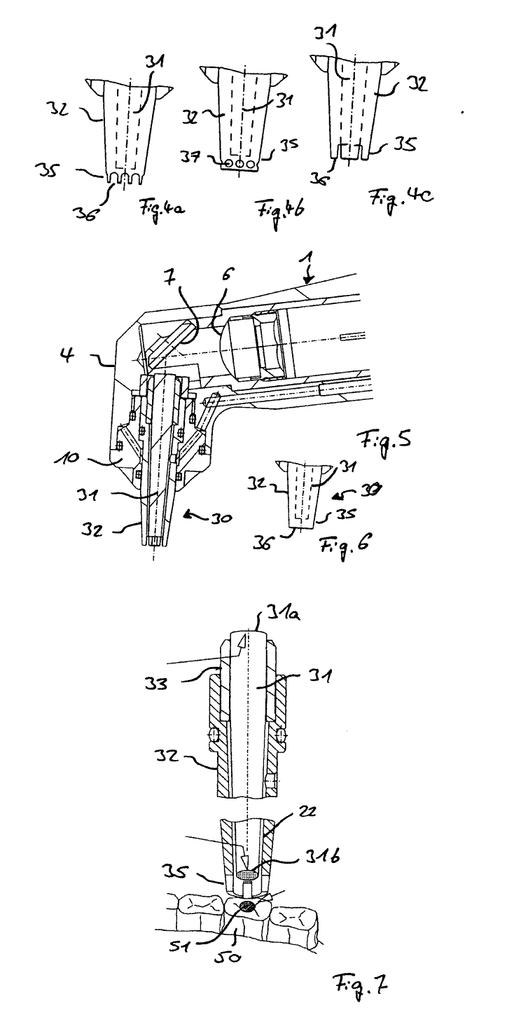

FIG. 3 shows an illustration for positioning the optical extraction element during the treatment of a dental surface;

FIGS. 4a to 4c show variants for implementing the sleeve-type holding element;

FIG. 5 shows a sectional view of the front head area of a second embodiment example of a laser treatment instrument according to the invention;

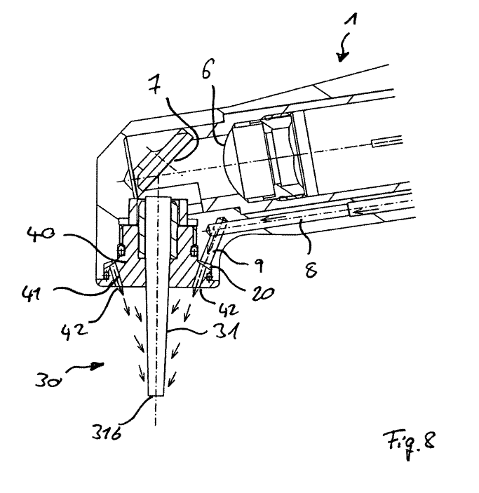

FIG. 6 shows a lateral view of the front end of the optical extraction element of the laser treatment instrument of FIG. 5;

FIG. 7 shows a schematic illustration of the functioning mode of the means for focusing the laser radiation according to the invention; and

FIG. 8 shows a view of a third embodiment example of a laser treatment instrument according to the invention.

The laser treatment instrument according to the invention, which is shown in FIG. 1 and which is designated with the reference numeral 1, includes an elongate handpiece 2 provided on its rear side 3 with coupling elements which are not shown in more detail and which enable the connection of the handpiece 2 to a supply tube leading to a supply unit. By means of this supply tube, on the one hand laser radiation is supplied, and on the other hand, a treatment fluid such as for example water is supplied. As the laser radiation, preferably the radiation of an Er:YAG laser is used which emits radiation in the order of 2.94 μm.

Laser radiation is emitted by means of an extraction element 30 disposed in the head area 4 of the handpiece 2, which extends particularly at an angle of approx. 100° relative to the longitudinal axis of the handpiece 2. The extraction element 30 has—as will be explained in more detail below—an elongate optical fiber, across the front surface of which the laser radiation is emitted.

The treatment of a dental surface by means of laser radiation emitted by the laser treatment instrument 1 becomes especially effective particularly if cooling by means of wetting the area with water is achieved. To this end, water as a sterile coolant is continuously supplied to the treatment area during treatment. In particular it is provided that the optical fiber of the optical extraction element 30 is rinsed with water, and to this end, particular measures for supplying the water are provided, as will be explained below.

First of all, FIG. 2 shows a cross-sectional view of the front handpiece area, where it can be seen that the laser radiation is supplied via a channel 5 extending along the longitudinal axis of the handpiece, and is directed onto a mirror 7 by means of a lens assembly 6. The mirror 7 in its turn changes the direction and corresponding introduction of the laser radiation into the optical fiber 31 of the extraction element. Here, the laser radiation is introduced into the front face 31a of the fiber 31.

The extraction element 30 is positioned by means of a guiding portion 10 in the head area 4 of the handpiece 2. This guiding portion 10 has a central through-opening 11 for releasably accommodating the extraction element 30 and is screwed into the head area 4 of the handpiece. By means of corresponding O-rings 12 or 13, a seal between the guiding portion 10 and the handpiece 2 on the one hand and between the guiding portion 10 and the extraction element 30 on the other hand is achieved.

The extraction element 30 itself consists first of all of the elongate optical fiber 31 as well as of two cylinder- or sleeve-type holding elements 32 and 33. The inner sleeve 33 tightly encompasses the front face end of the optical fiber 31, whilst the outer sleeve 32 surrounds the fiber 31 at a certain distance. In this way, an elongate annular space 22 surrounding the fiber 31 is formed, which is used as a channel for dispensing the water. This means that during the later operation of the handpiece 1, this channel 22 is used to flush the fiber 31, so that water may be supplied. The water initially enters via bores 8, 9 in the handpiece sleeve 2 into an annular channel 20 formed on the outside of the guiding portion 10 and flows via several through-bores 16 into a further annular channel 21 which is formed on the inside of the guiding portion 10. Starting from this second annular channel 21, the water is then guided through one or several bores 34 into the inside of the sleeve-type holding element 32 into the free space 22.

The particularity of the present invention consists in that, contrary to the solution provided by the U.S. Pat. No. 6,567,582, it is provided that the outer sleeve 32 for forming the channel 22 surrounds the fiber 31 up to the front end thereof and even extends a certain distance beyond it. By this means, a continuous channel 22 for dispensing water is ultimately formed, which extends up to the dental surface to be treated, as is shown in the enlarged view of FIG. 3. First of all, this leads to the water being supplied to the area to be treated in an effective manner and correspondingly to an effective cooling thereof.

A further aspect which follows from the embodiment of the outer sleeve 32 according to the invention is that this provides the possibility of positioning the optical fiber 31 in a defined disposition relative to the dental surface in a simple manner. Since the sleeve 32 extends beyond the fiber 31 by a specified dimension d, the sleeve 32 may be placed in a simple manner with its front face 36 on the surface of the tooth 50, which ultimately results in the fiber 31 being located at a certain distance from the surface. In this way it may be ensured by means of a corresponding focusing of the laser radiation that the latter will always be directed onto the surface to be treated in a particularly effective manner.

In the embodiment example illustrated, the front sleeve section 35 of the sleeve 32 is perforated, as a result of which the cooling medium as well as any dental substance removed may flow off. This leads to a further improvement of the cooling and rinsing of the surface to be treated, which ultimately results in an improved treatment. The provision of corresponding lateral openings for carrying off the water and the dental matter may be carried out by various means, as is illustrated by the three variants shown in FIGS. 4a to 4c. As has already been mentioned, the front face area 36 in the sleeve 32 may be perforated in an appropriate manner. However, it is also contemplated that lateral bores 37 are disposed in a ring-like manner in the protruding sleeve section 35, as shown in FIG. 4b. In principle, by means of this particular embodiment of the sleeve 32 the advantage is achieved that on the one hand, the optical fiber 31 may be positioned in an optimal manner in relation to the surface to be treated. Moreover, the coolant is supplied in an effective manner and the surface to be treated may be rinsed.

As shown by the illustrations of FIGS. 5 and 6, wherein like elements were given the same reference numerals, the perforation or the openings in the front sleeve section 35 may also be dispensed with. In this case, the sleeve 32 extends in a closed manner up to the front face end 36. As before, also in this case a good supply of water to the surface to be treated as well as an optimal positioning of the optical fiber 31 are achieved. In this case, the water supplied to the treatment area flows off laterally from the treatment area below the front face 36 of the sleeve 32, but compared to the variants described above, the rinsing achieved is not quite as good.

A further advantage achieved by using a sleeve 32 extending beyond the optical fiber 31 may be seen in the illustration given in FIG. 7. Due to the defined distance of the light output surface 31b of the optical fiber 31 to the surface of the tooth 50, the effect is achieved that the working beam diameter, i.e. the size of the light spot 51 of the laser radiation on the dental surface, is smaller than or equal to the output area 31b of the optical fiber. As a result of this, the laser radiation transferred via the handpiece 1 may be directed in a particularly effective and concentrated manner onto the dental surface to be treated. In this case, the laser radiation is not focused through the light output area 31b of the optical fiber 31, as is known for example from U.S. Pat. No. 5,304,167, but in the case of the embodiment example of FIG. 7, through the light entry area 31a of the optical fiber 31. According to the illustration, this is formed slightly convex and results in the laser radiation being focused through the fiber 31 onto the surface of the tooth 50.

As an alternative to focusing via the light entry area 31a of the fiber 31, there would also be a possibility of using elements positioned upstream of the optical fiber 31. In the illustrations shown in FIGS. 2 and 5, for example, the light entry area 31a of the fiber 31 is formed to be flat. Here, focusing is predominantly carried out by means of a lens 6 or a lens assembly located in the grip sleeve 2 of the handpiece 1. The light bundled through this lens 6 is then introduced into the optical fiber by means of the mirror 7 in such a way that it will be focused as desired onto a spot spaced apart from the light output area 31b of the fiber 31.

Finally, a further embodiment example of a laser treatment instrument 1 according to the invention will be described by means of the illustration shown in FIG. 8. This again is arranged in a special manner in order to achieve optimal cooling and rinsing of the preparation surface. Contrary to the embodiment examples described above, however, where the optical fiber 31 was continuously surrounded by a sleeve, the front area of the optical fiber 31 is not encapsulated here. In this case, the preparation surface is cooled by means of a special guiding portion 40, which in its turn is disposed in the head area 4 of the handpiece 1 and has a central opening for accommodating the optical fiber 31. In this guiding portion 40, also through-bores 41 distributed around the optical fiber 31 are formed, which are connected to the through-bores 8 and 9 of the handpiece 1 by an annular channel 22 for supplying the treatment medium. These through-bores 41 are connected to outlets 42 forming nozzles, through which the water is directed onto the optical fiber 31, in particular onto the front end of the optical fiber 31. These nozzles 42 are distributed around the optical fiber 31 in a ring-shaped manner, so that an optimal cooling and rinsing of the treatment area from all sides may be achieved. Contrary to the embodiment examples described above, however, it is not possible to position the optical fiber 31 in a simple manner in a defined manner [sic] opposite the dental surface to be treated.

Ultimately, by means of the illustrated embodiment examples, a dental laser treatment instrument is provided wherein the dental surface may be treated in an optimal manner. On the one hand, the positioning of the handpiece and thus the orientation of the laser radiation onto the surface to be treated is facilitated, and on the other hand, an optimal cooling as well as rinsing of the dental surface is achieved.

1-14. (canceled)

15. A dental laser treatment instrument comprising a handpiece to be connected to a supply tube for supplying laser radiation and a treatment fluid, at a front end of which an elongate extraction element for emitting laser radiation is disposed, said extraction element including an elongate optical fiber having a front light output end, and a cylinder- or sleeve-type holding element that surrounds the optical fiber at a distance in an area facing the front end of the fiber to form a fluid channel, and wherein the fluid channel is connected to a supply line extending through the handpiece, wherein the cylinder- or sleeve-type holding element extends beyond the front light output end of the optical fiber.

16. The dental laser treatment instrument of claim 15, wherein the cylinder- or sleeve-type holding element includes lateral openings in the area extending beyond the optical fiber.

17. The dental laser treatment instrument of claim 16, wherein the openings are formed by bores provided in a sleeve section extending beyond the optical fiber.

18. The dental laser treatment instrument of claim 16, wherein a front face of a sleeve section extending beyond the optical fiber is perforated.

19. A dental laser treatment instrument comprising a handpiece to be connected to a supply tube for supplying laser radiation and a treatment fluid, at the front end of which an extraction element having an elongate optical fiber for emitting laser radiation is located, with the handpiece further including a holding element for the optical fiber, which is connected to a supply line extending through the handpiece and which is designed to dispense the treatment fluid, wherein the holding element has several outlets for the treatment fluid, which are distributed around the optical fiber.

20. The dental laser treatment instrument of claim 19, wherein the outlets are distributed around the optical fiber in a ring-shaped manner.

21. The dental laser treatment instrument of claim 19, wherein nozzles are formed through the outlets, through which the treatment fluid is directed onto the tip of the optical fiber.

22. The dental laser treatment instrument of claim 15, comprising means for focusing the laser radiation having an area located upstream of the light output end of the optical fiber.

23. The dental laser treatment instrument of claim 22, wherein the means for focusing the laser radiation is disposed upstream of the optical fiber or is formed through the light entry area of the optical fiber.

24. A dental laser treatment instrument comprising a handpiece, at a front end of which an extraction element having an elongate optical fiber for emitting the laser radiation is provided, wherein the handpiece includes means for focusing the laser radiation onto an area located upstream of a light output end of the optical fiber, wherein the means for focusing is located upstream of the optical fiber or is formed through the light entry area of the optical fiber.

25. The dental laser treatment instrument of claim 24, wherein the light entry area of the optical fiber is convex.

26. The dental laser treatment instrument of claim 24, wherein a lens or lens assembly for focusing the laser radiation is located upstream of the optical fiber.

27. The dental laser treatment instrument of claim 24, comprising a mirror assembly for introducing the laser radiation focused by the lens or lens assembly into the optical fiber.

28. An optical extraction element for a dental laser treatment instrument, the optical extraction element being formed at a front end of a handpiece and being designed to emit laser radiation, with the extraction element having an elongate optical fiber and a cylinder- or sleeve-type holding element that surrounds the optical fiber at a distance in an area facing a front end of the fiber to form a fluid channel, and wherein the fluid channel is connected to a supply line for fluid extending through the handpiece, wherein the cylinder- or sleeve-type holding element extends beyond a front light output end of the optical fiber.
